(19) United States
(12) Patent Application Publication
(10) Pub. No.: US 2024/0043132 A1
(43) Pub. Date: Feb. 8, 2024

(54) COOLING SYSTEM FOR AN AIRCRAFT, AIRCRAFT HAVING A COOLING SYSTEM, AND METHOD FOR COOLING AN ELECTRIC PROPULSION SYSTEM OF AN AIRCRAFT

(71) Applicant: MTU Aero Engines AG, Muenchen (DE)

(72) Inventor: Barnaby LAW, Starnberg (DE)

(21) Appl. No.: 18/266,073

(22) PCT Filed: Nov. 26, 2021
(86) PCT No.: PCT/DE2021/100939

§ 371 Date: Jun. 8, 2023

(30) Foreign Application Priority Data
Dec. 16, 2020 (DE) 102020216090.2

(51) Int. Cl. B64D 33/08; B60L 58/33; H01M 8/04029

(52) U.S. Cl. CPC B64D 33/08; B60L 58/33; H01M 8/04029; B64D 27/24

(57) ABSTRACT

A cooling system (10) for an aircraft is provided, in particular for cooling at least one element of an electric propulsion system (24) of the aircraft, the cooling system (10) being at least partially disposed within a wing (12) of the aircraft and including at least two heat exchangers (16, 42) interconnected via at least one cooling circuit (11), the first heat exchanger (16) being operatively connected to the at least one element to be cooled of the electric propulsion system (24), and the second heat exchanger (42) being disposed within at least one wing (12) and being operatively connected to an upper and/or lower wing shell (46, 48) of the wing (12). A method for cooling at least one element of an electric propulsion system (24) of an aircraft is also provided.

The present invention relates to a cooling system for an aircraft. The invention also relates to an aircraft having such a cooling system, to a wing of an aircraft having such a cooling system, and to a method for cooling an electric propulsion system of an aircraft.

### BACKGROUND

Cooling systems for aircraft, in particular for aircraft having an electric propulsion system, are facing new challenges. In aviation, fuel cells are playing an increasingly important role in supplying electrical power to the airplane. Apart from supplying the on-board electrical system with electrical power, fuel cells can also be used to power the electric propulsion system of an electrically operated airplane.

### SUMMARY OF THE INVENTION

In addition to electrical power, fuel cells also produce thermal energy. In order to maintain the fuel cell at an optimal operating temperature, the fuel cell and electric propulsion system must be cooled. In the prior art, there are known cooling systems which work, for example, with cooling air. U.S. Pat. No. 10,316,693 B2 presents a cooling system that is installed in the tail region of an airplane and enables supply of cooling air using channels formed in the outer skin of the airplane. Such channels in the outer skin have the disadvantage of affecting the aerodynamics of the airplane. US 2016/0036071 A1 describes a cooling system in the fuselage, which removes heat from the fuel cell via a heat exchanger traversed by a liquid coolant. A cooling system of this type has the disadvantage of adding weight to the fuselage.

It is an object of the present invention to provide a cooling system for an aircraft which ensures effective cooling of at least one element of an electric propulsion system of the aircraft. A further object of the invention is to provide a method for cooling an electric propulsion system of an aircraft which ensures effective cooling of at least one element of an electric propulsion system of the aircraft.

The present invention provides a cooling system, a wing of an aircraft, an aircraft, and a method for cooling at least one wing-mounted electric propulsion system of an aircraft. Advantageous embodiments including useful refinements of the invention are defined herein. Advantageous embodiments of each inventive aspect are considered to be advantageous embodiments of the respective other inventive aspects.

A first aspect of the invention relates to a cooling system for an aircraft, in particular for cooling at least one element of an electric propulsion system of the aircraft, the cooling system being at least partially disposed within a wing of the aircraft and including at least two heat exchangers interconnected via at least one cooling circuit, the first heat exchanger being operatively connected to the at least one element to be cooled of the electric propulsion system, and the second heat exchanger being disposed within at least one wing and being operatively connected to an upper and/or lower wing shell of the wing.

In other words, the invention provides for a cooling system to be installed at least partially within the wing of the aircraft, the cooling system interconnecting two heat exchangers via a cooling circuit. A coolant, in particular a liquid coolant, flows in the cooling circuit. The liquid coolant serves to carry excess heat generated during operation of the propulsion system away from an element of the electric propulsion system so as to maintain effective operation of the element of the electric propulsion system or of the overall propulsion system. Waste heat of the element to be cooled of the electric propulsion system is absorbed at the element by the liquid coolant. This is accomplished via the first heat exchanger, which is operatively connected to the element to be cooled, and in such a manner as to obtain the best possible heat transfer from the element to the liquid coolant flowing through the heat exchanger. To be able to remove heat from the at least one element to be cooled of the electric propulsion system, the first heat exchanger may be embodied as a separate device. However, in accordance with the invention, it is also possible that a specific structure through which the coolant flows may be formed in and/or on the housing of the element of the electric propulsion system or of the propulsion system itself. Such a system may be in the form of, for example, channels or conduits through which the liquid coolant is passed. Consequently, heat generated during operation of the element to be cooled of the electric propulsion system is reliably transferred to the coolant circulating in the cooling circuit.

The coolant heated in the first heat exchanger is conveyed to the second heat exchanger via the cooling circuit. To this end, for example, at least one pump may be disposed in the cooling circuit. The second heat exchanger is disposed within the wing of the aircraft and is operatively connected to the upper and/or lower wing shell of the wing. This means that the second heat exchanger is in direct contact with the upper and/or lower wing shell or disposed relative to the upper and/or lower wing shell in such a manner so as to allow heat exchange or heat transfer through the second heat exchanger. The second heat exchanger may, for example, cause the heat absorbed at the element to be cooled of the electric propulsion system to be dissipated into the ambient air, thereby cooling down the liquid coolant. The expression “within” the wing should be considered to refer to the interior space within the wing of the aircraft. The interior space of the wing is defined and bounded by the upper shell and the lower shell of the wing, a certain free space being available as an interior space between the upper shell and the lower shell, depending on the type of wing. The air in the interior space is in thermal interaction with the wing shells of the airplane wing and releases the heat absorbed by the liquid cooling circuit through an upper and/or a lower wing shell into the usually colder outside air. However, it is also possible that the second heat exchanger may be cooled directly through the upper and/or lower wing shell by using the wing surfaces as surface heat exchangers; i.e., by effecting a thermal coupling to the wing shells. In this region of the cooling system, the cooling of the liquid coolant is effected by the thermal conductivity of the wing shells and the temperature difference between an external flow during flight and the interior of the wing or the liquid coolant within the second heat exchanger. Furthermore, the conduit system of the cooling circuit may also be cooled by the air in the interior space or by direct contact with the wing shells in such a manner that a thermal coupling to the external flow is effected by the thermal conductivity of the material of the conduit system and the thermal conductivity of the material of the wing shell.

At the element to be cooled of the electric propulsion system, the inventive cooling system advantageously provides indirect cooling via the first heat exchanger by means of a liquid coolant. Compared to air cooling, cooling via a liquid coolant has the advantage of enabling the dissipation of larger quantities of heat. This makes it possible to effectively cool the element to be cooled and to keep it at the operating temperature required for operation. This has a positive effect on, for example, the fuel consumption of a fuel cell that is to be cooled as the element of an electric propulsion system. This applies similarly to all elements to be cooled of the electric propulsion system that are also capable of being effectively cooled. The element to be cooled of the electric propulsion system may, for example, be the aforementioned fuel cell for powering the electric propulsion system and/or a fuel cell stack for powering the electric propulsion system and/or a battery for powering the electric propulsion system and/or an electric motor of the electric propulsion system and/or a housing of the electric propulsion system. Other heat-generating elements and components of the electric propulsion system can also be reliably and effectively cooled.

Since the cooling system according to the invention provides a cooling circuit that effectively cools at least one element of the electric propulsion system, a known prior art cooling device for a propulsion system, which allows cool outside air to be supplied directly to the propulsion system through air inlets directly at the propulsion system, can be adjusted in such a manner that the air supply, and thus the air inlets of the main heat exchanger, do not need to provide the full heat dissipation and cooling. Therefore, during take-off of the aircraft and also during the further course of the flight, the aerodynamic drag is reduced because the air inlets of the cooling device do not need to deliver the full air supply.

Liquid coolants suitable for use in the inventive cooling system include all known liquids. For example, it is possible to use cooling oils or ethylene glycol/water.

An advantageous embodiment of the invention provides that the cooling system include at least one fan disposed within the wing. This means that at least one fan is mounted in the interior space of the wing. The at least one fan assists the convection of air within the wing, thereby ensuring good heat transfer from the cooling circuit to the air within the wing and from the air within the wing to the upper and/or lower wing shell. A thermal interaction is established between the liquid cooling circuit and the upper and/or lower wing shell. Thus, the heat absorbed at the element to be cooled of the electric propulsion system can be reliably removed from the cooling circuit.

In another advantageous embodiment of the cooling system according to the invention, at least one conduit is provided for supplying the liquid coolant to the first heat exchanger as well as a conduit for conveying the liquid coolant away from the first heat exchanger.

Another advantageous embodiment of the invention provides that the cooling system according to the invention include a tank system having at least one tank for storing the liquid coolant, the tank system being installed within the wing. The tank system may include one or more tanks. Examples of materials that can be selected for the manufacture of the tanks include materials with high thermal conductivity, such as aluminum or aluminum alloys. Thus, the tank may advantageously be used as the second heat exchanger because heat is here reliably transferred from the liquid coolant via the air in the interior space of the wing to the shells of the wing. However, it is also possible that at least a portion of a tank wall may be in direct thermal interaction with the upper and/or lower wing shell of the airplane wing; i.e., that at least a portion of a tank wall may be in contact with the respective inner surface of the upper and/or lower wing shell. This also ensures reliable heat transfer and a corresponding removal of heat from the liquid coolant.

The tank system may include at least one outlet device for the liquid coolant and at least one inlet device for the liquid coolant. In other words, the outlet device at the tank system conveys the liquid coolant into a conduit element of the cooling circuit. Via the inlet device at the tank system, the liquid coolant flows from the cooling circuit back into the tank.

An advantageous embodiment of the invention provides that the tank system be configured such that a total weight of the tank system and the liquid coolant stored therein is determined based on a load and structural analysis of a weight ratio between the fuselage and the wings of the airplane. This means that the tank system in the wing can carry a weight of liquid coolant that is optimal for the weight ratio between the fuselage and the wings. The amount of liquid coolant in the wing that is optimal for lift can be calculated by a corresponding load analysis and structural analysis of the entire aircraft. In this connection, it is also possible to carry an amount of liquid coolant that exceeds the minimum amount required to cool the element to be cooled of the electric propulsion system. This is because for optimal lift of the aircraft, it is required that the wing have an optimized weight in relation to loads which are mainly derived from aerodynamics. Since, for example, the fuel for a fuel cell, such as liquid hydrogen, is typically stored in the form of spherical or cylindrical fuel tanks in the fuselage of the aircraft, such as an airplane, the free space inside the wing can be used for the inventive cooling system including the described liquid coolant tank system, and the inventive cooling system thus serves at the same time as a substitute for the missing weight of the fuel or fuel tank in the wing of conventional airplanes. In particular, the weight of the coolant tanks, together with the liquid coolant, may be selected such that the weight of the liquid coolant serves as a substitute for the weight of the fuels stored in the wing of non-electrically operated airplanes.

In a further advantageous embodiment, the cooling system according to the invention includes a tank system having a predetermined number of tanks and a predetermined distribution of the tanks such that a weight distribution in the wing is balanced out. In other words, through load and/or structural analyses, it is possible to determine a weight distribution in the wing, which is then ensured in the wing by a specific distribution of the tanks in the interior space of the wing and a predetermined number of tanks, respectively. The weight distribution required in the wing can be accomplished through a load and structural analysis of the wing and of the entire aircraft according to the particular type of aircraft.

In an advantageous embodiment of the cooling system according to the invention, at least one fan is disposed above and/or below each of the individual tanks of the tank system for the convection of the air in the interior space of the wing along the respective tank. This contributes to the effectiveness of the tank that serves as the second heat exchanger and does so by establishing an optimal thermal interaction between the liquid in the cooling circuit, the air in the interior space of the wing, and the outside air. The air in the interior space of the wing is thus effectively circulated between the conduit and tank system of the cooling circuit and the upper and/or lower wing shells, which establish the thermal interaction with the cooler outside air.

In another advantageous embodiment of the invention, the cooling system has at least one sensor for sensing a temperature of the liquid coolant in the tank system. In a further embodiment, at least one sensor for sensing an air temperature within the airplane wing is provided. A further embodiment also provides that the cooling system have at least one sensor for sensing an outside temperature on the wing.

In other words, provision is made that individual sensors make temperature measurements which ensure that the inventive cooling system operates in a predetermined temperature range. The individual temperature sensors provide feedback about the respective temperature and can thus cause the cooling system to operate in the proper temperature range and thereby keep the element to be cooled of the electric propulsion system at the predetermined operating temperature. The measurement of the air temperature within the wing and the measurement of the outside temperature may both influence the activity of the fans (e.g., fan speed) via a feedback system, for example. It may also be provided that the particular measured temperature influence the velocity of flow and/or the volume of flow of the liquid coolant through the first heat exchanger and/or the second heat exchanger.

An advantageous embodiment provides that the inventive cooling system include at least one ground conduit for ground cooling such that the ground conduit is in thermal interaction with the tank system. In this context, “ground cooling” means that while the aircraft stands still on the ground, cooling units are available which can be connected to the cooling system according to the invention. More particularly, the cooling units can be connected to the aforementioned ground conduits, the ground conduits also being traversed by the flow of the fluid coolant of the cooling system. Since the ground conduits are routed along the tanks, good cooling of the tanks is achieved even when the aircraft stands still on the ground. However, it is also possible that at least one heat exchanger may be disposed between the ground conduit and the tanks, the heat exchanger being in thermal interaction with the ground conduit and the tank. The at least one heat exchanger may be configured within and/or outside of the tank.

Good cooling of the tanks is important especially in the case of high outside temperatures prevailing on the ground; i.e., mostly under hot conditions or extreme hot conditions. The additional ground cooling of the tanks is provided, for example, to suitably precool the liquid coolant prior to a taxiing phase of the aircraft so that the take-off procedure of the aircraft can already take place with effective cooling via the cooling system according to the invention. In this connection, it is advantageous that the amount of liquid coolant in the tanks exceed a minimum amount so as to increase the thermal inertia of the volume of liquid coolant. The possibility to provide ground cooling ensures better take-off performance of the aircraft at higher temperatures. This can be further assisted by suitably selecting a liquid coolant of higher or lower heat capacity.

A second aspect of the invention relates to a wing for an aircraft, including at least one cooling system according to the first aspect of the invention. As mentioned earlier, the integration of the cooling system on the wing, the cooling system being at least partially disposed within the airplane wing, has the advantage that the interior space of the wing can be used to provide a cooling system that is effective for cooling at least one element of an electric propulsion system. Further features of the second aspect of the invention and the advantages thereof may be inferred from the description of the first aspect of the invention.

A third aspect of the invention relates to an aircraft having at least one cooling system according to the first aspect of the invention. Further features of the third aspect of the invention and the advantages thereof may be inferred from the description of the first and second aspects of the invention.

A fourth aspect of the invention relates to a method for cooling at least one element of an electric propulsion system of an aircraft, the method including at least the following steps: (a) providing a cooling system according to the first aspect of the invention, (b) measuring a temperature in the region of the element to be cooled of the electric propulsion system, and (c) controlling the volume of flow and/or the velocity of flow of the liquid coolant in the cooling system according to the deviation of the temperature measured in step (b) from a predetermined desired temperature for the element to be cooled.

In other words, the cooling system is controlled in accordance with the invention such that a predetermined desired temperature or working temperature of the element to be cooled of the electric propulsion system is maintained so as to keep the element at an optimum operating temperature. To this end, temperature measurements are made at different locations in the cooling circuit and the propulsion system. Via pumps in the cooling circuit, it is possible, for example, to set the delivery volume and/or the delivery velocity of the liquid coolant, to control the volume of flow and/or the velocity of flow of the liquid coolant through the first heat exchanger and/or the second heat exchanger and thereby also the quantity of heat absorbed at the element to be cooled of the propulsion system.

In an embodiment of the method according to the invention, the method may include the following additional steps: For example, in a method step (d), the temperature of the liquid coolant in the cooling circuit may be measured, and, in a method step (e), the volume of flow and/or the velocity of flow of the liquid coolant in the cooling system may be controlled taking into account the temperature measured in step (d). In other words, the temperature difference between the liquid coolant and the temperature present in the region of the element to be cooled of the propulsion system influences the heat transfer occurring in the region of the first heat exchanger, and thus also the quantity of heat that can be absorbed by the coolant. Therefore, there may be provided a feedback system that controls the velocity of flow of the liquid coolant as a function of the temperature of the liquid coolant.

Further features of the fourth aspect of the invention and the advantages thereof may be inferred from the description of the first, second, and third aspects of the invention.

### BRIEF DESCRIPTION OF THE DRAWINGS

Other features of the invention will become apparent from the claims, the exemplary embodiments, and from the drawings. The aforementioned features and feature combinations, as well as the features and feature combinations mentioned below in the exemplary embodiments, may be used not only in the particular stated combination, but also in other combinations, without departing from the scope of the present invention.

In the drawing,

FIG. 1 is a schematic view of the inventive cooling system according to a first exemplary embodiment;

FIG. 2 is a schematic view of a tank system of an inventive cooling system according to a second exemplary embodiment;

FIG. 3 is a schematic view of a tank system of an inventive cooling system according to a third exemplary embodiment; and

FIG. 4 is a schematic side view of a tank system of an inventive cooling system according to a fourth exemplary embodiment.

### DETAILED DESCRIPTION

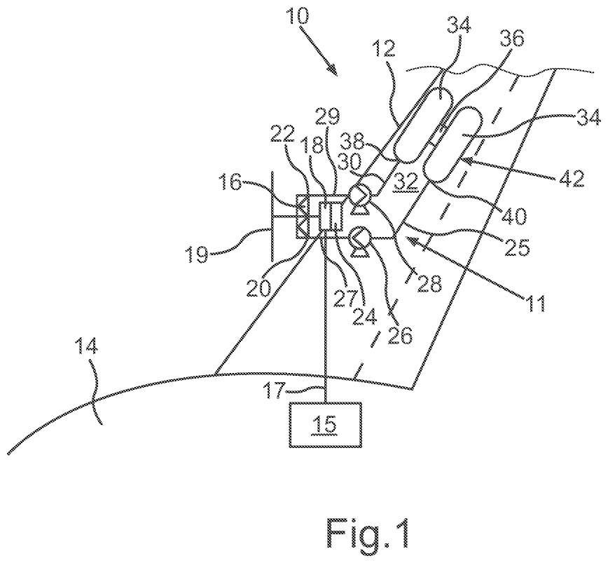

FIG. 1 illustrates schematically the arrangement of a cooling system 10 in a wing 12 of an aircraft, namely an airplane, according to a first exemplary embodiment. A fuselage 14 is fragmentarily indicated opposite the wing 12. Cooling system 10 includes a first heat exchanger 16, the first heat exchanger 16 being operatively connected to an element to be cooled of an electric propulsion system 24 of the airplane. In the exemplary embodiment shown, the element to be cooled of a fuel cell 18 for supplying electrical energy to propulsion system 24 is-stands to absorb the waste heat of fuel cell 18. In this connection, a cooling circuit 11 connects first heat exchanger 16, which absorbs the waste heat of fuel cell 18, to a second heat exchanger 42 within wing 12. First heat exchanger 16 is disposed in or on fuel cell 18, so that a heat transfer occurs when the liquid coolant flows in or past fuel cell 18. In accordance with the exemplary embodiment shown, fuel cell 18 is disposed within wing 12.

In FIG. 1, by way of example, electric propulsion system 24 is disposed directly adjacent to fuel cell 18 and drives a propeller 19. Electric propulsion system 24 may be, for example, an electric motor. A fuel cell is a galvanic cell that converts the chemical reaction energy of a continuously supplied fuel and an oxidation agent to electrical energy. In the present exemplary embodiment, the energy generated by fuel cell 18 is used for electric propulsion system 24. In accordance with the exemplary embodiment of FIG. 1, a fuel tank 15 for storing the fuel is accommodated in fuselage 14, and, via a fuel feed line 17, fuel cell 18 is continuously supplied with fuel during operation.

First heat exchanger 16 is so positioned relative to fuel cell 18 that good heat transfer can occur from fuel cell 18 to cooling system 10. First heat exchanger 16 has a coolant inlet 20 and a coolant outlet 22. In accordance with the exemplary embodiment shown, first heat exchanger 16 is depicted as a separate device. However, this does not necessarily have to be the case. First heat exchanger 16 may also be, for example, a specific structure in the housing of fuel cell 18, through which the coolant flows, or, for example, channels or conduits through which the liquid coolant is passed along or through fuel cell 18. As a result, heat generated during the power generation process of the fuel cell is transferred to the liquid coolant flowing in cooling circuit 11.

It can be seen that a first pump 26 and a second pump 28 are disposed in cooling circuit 11 for pumping the liquid coolant. First pump 26 pumps the liquid coolant to first heat exchanger 16, and more specifically from a conduit element 25 upstream of pump 26 into a conduit element 27 downstream of pump 26, conduit element 27 ensuring supply of the liquid coolant to first heat exchanger 16. Second pump 28 pumps the liquid coolant from first heat exchanger 16 via a conduit element 29 and a conduit element 30 further in cooling circuit 11 toward second heat exchanger 42.

A tank system 32 for storing the liquid coolant is disposed within wing 12; i.e., in an interior space 44 of wing 12. In the exemplary embodiment of FIG. 1, cooling system 10 includes two separate tanks 34 for the liquid coolant, these tanks being connected in fluid communication with each other via a connecting element 36. The liquid coolant is fed to tanks 34 via an inlet device 38. Tank system 32 further has an outlet device 40, from which the liquid coolant is fed to conduit element 25. First pump 26 then pumps the liquid coolant further to first heat exchanger 16. Tank system 32 is part of cooling circuit 11. In the exemplary embodiment of FIG. 1, two tanks 34 are provided, both of which are disposed in wing 12. However, it is also possible that only one tank 34 or a plurality of tanks 34 for the liquid coolant may be disposed in wing 12 and together form a connected tank system 32 for cooling system 10. As is also shown in FIG. 1, tanks 34 may be cylindrical vessels. However, the shape of tanks 34 is not limited thereto. In accordance with the exemplary embodiment, conduit element 30 also extends within airplane wing 12 and conveys the liquid coolant of cooling circuit 11 to tank system 32. In accordance with the exemplary embodiment shown, the further conduit element 25 is disposed within airplane wing 12 and conveys the liquid coolant away from the tank system.

It can be seen that in the region of second heat exchanger 42, the quantity of heat absorbed at first heat exchanger 16 can be removed from cooling circuit 11 so as to keep the temperature of the liquid coolant at a predetermined temperature, and to thereby be able to ensure effective cooling of fuel cell 18. In this process, tanks 34 act as heat exchangers, the liquid coolant heated by first heat exchanger 16 being able to effectively dissipate heat to the cooler air in the interior space of wing 12 by heat transfer or heat transmission through surface 54 of tanks 34.

The air in the interior space establishes a thermal interaction with an upper and/or lower wing shell 46, 48 of wing 12, and thus with an external air flow during flight. However, a thermal interaction may also be established through direct contact of the material of a tank wall of tank 34 with the material of the wing shells, so that a thermal coupling to the external air flow is effected by the thermal conductivity of the material of the tank wall and the thermal conductivity of the material of wing shell 46, 48. Typically, the temperature of the external air flow is significantly below the temperature of the air in interior space 44 of wing 12 and thus causes a significant temperature gradient for effective heat transfer. This allows the heat absorbed at fuel cell 18 to be effectively removed from the cooling circuit.

Second heat exchanger 42 may also act along conduit elements 25, 27, 29, 30. To this end, conduit elements 25, 27, 29, 30 of cooling circuit 11 extend entirely or at least partially in interior space 44 of wing 12, a heat transfer occurring to the air in the interior space. Via the cooler air in interior space 44, a thermal interaction is then in turn established with upper shell 46 and/or lower shell 46, 48 of wing 12. However, the thermal interaction may also be established through direct contact of the conduit system of cooling circuit 11 with wing shells 46, 48, so that a thermal coupling to the external air flow is effected by the thermal conductivity of the material of the conduit system and the thermal conductivity of the material of wing shells 46, 48.

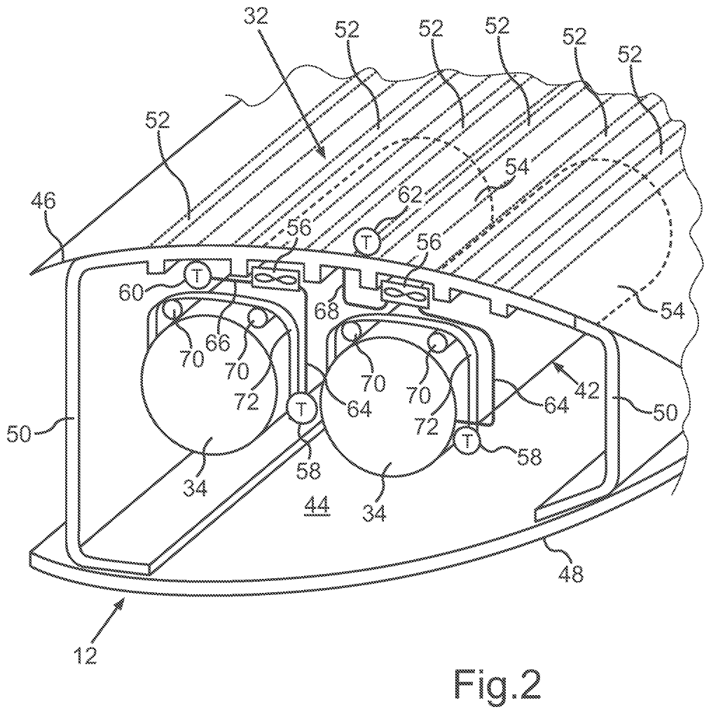

FIG. 2 shows schematically a tank system 32 for storing the liquid coolant in the interior space 44 of a wing 12 of an aircraft, namely an airplane, according to a second exemplary embodiment of cooling system 10. Shown is a schematic cross-section through wing 12. Interior space 44 of wing 12 is defined by the two shells 46, 48 of wing 12. FIG. 2 also shows further details of the configuration of wing 12, including a front and a rear spar 50. Stringers 52 of airplane wing 12, which extend parallel to the longitudinal axis of airplane wing 12, are schematically illustrated at upper shell 46.

Moreover, tanks 34 are shown in cross section, illustrating the arrangement of tanks 34 in interior space 44 of wing 12. In FIG. 2, tanks 34 are of circular cross section and are arranged cylindrically along the longitudinal extent of stringers 52. However, the configuration of tanks 34 is not limited to this form. Other cross sections may also be selected for the tanks 34 for storing the liquid coolant. Tanks of cuboid shape, for example, are also possible. A plurality of tanks 34 may be disposed in the interior space 44 of the wing. In this case, tanks 34 may extend parallel to each other. The positioning of tanks 34 may be performed based on an analysis of a weight distribution that is favorable for wing 12 and for the lift of the airplane. FIG. 2 further illustrates how, during operation of cooling system 10, heat may be dissipated by air convection along surface 54 of tanks 34 and along wing shells 46, 48. For this purpose, tanks 34 are arranged in wing 12 such that there is good heat transfer between the air in interior wing space 44 and tanks 34. In order to ensure good and sufficient convection of the air in interior space 44, at least one fan 56 is mounted in interior space 44 of wing 12. In accordance with the exemplary embodiment shown, at least one fan 56 is disposed at upper shell 46 above each of the individual tanks 34. Furthermore, fans 56 are mounted top-down; i.e., in the region above a tank 34, and more specifically near top shell 46.

To be able to check the effectiveness of the heat transfer and the particular temperature within the cooling system, temperature sensors 58, 60, 62 are provided. Temperature sensors 58 disposed at tanks 34 measure the temperature of the liquid coolant in tanks 34. Temperature sensors 58 are connected to respective fans 56 via a first feedback system 64 so as to allow control of the fan settings, such as the speed. Furthermore, temperature sensors 60 may be provided to measure the temperature of the air in interior wing space 44. A second feedback system 66 for the air temperature measurement in interior wing space 44 may also be provided to control the fan setting. Temperature sensors 62 for measuring the outside temperature may be disposed on the wing. These may control the fan setting via a third feedback system 68.

The cooling system 10 according to this exemplary embodiment further includes ground conduits 70 for ground cooling, which, by way of example, are disposed above the respective tanks 34. These can be used while the airplane is on ground.

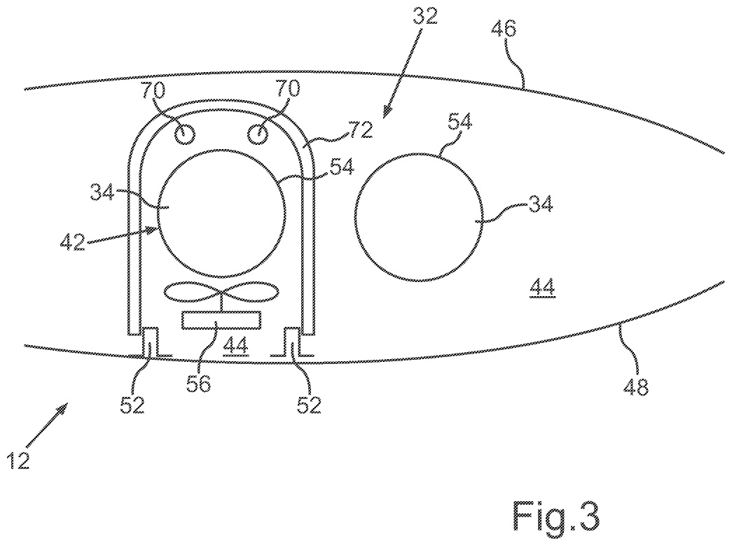

FIG. 3 shows schematically a tank system 32 for storing the liquid coolant in the interior space 44 of an airplane wing 12 according to a further exemplary embodiment of cooling system 10. There can be seen, in particular, the configuration of second heat exchanger 42. Fan 56 assists the air circulation in interior space 44 of airplane wing 12 between surface 54 of tanks 34 and wing shells 46, 48. In the exemplary embodiment shown, fan 56 is mounted in a bottom-up configuration; i.e., fan 56 is disposed between lower wing shell 48 and tank 34. In FIG. 3, only one fan 56 is shown, but a plurality of fans 56 may be disposed along tank 34. Fan 56 may, for example, be attached to lower shell 48 or to stringers 52. Here, in cross-sectional view, tanks 34 are shown to have a circular cross section, but other cross sections are also possible. Moreover, tanks 34 may extend spatially over a certain length of wing 12 or over the entire length of wing 12 along stringers 52. It is also possible, for example, that a tank 34 may extend widthwise over a plurality of stringers 52.

Ground conduits 70 for connection of additional cooling units for ground cooling when necessary are illustrated, by way of example, above the respective tanks 34. For purposes of mounting tank 34, mounting elements 72 are provided which secure tank 34 in interior wing space 44.

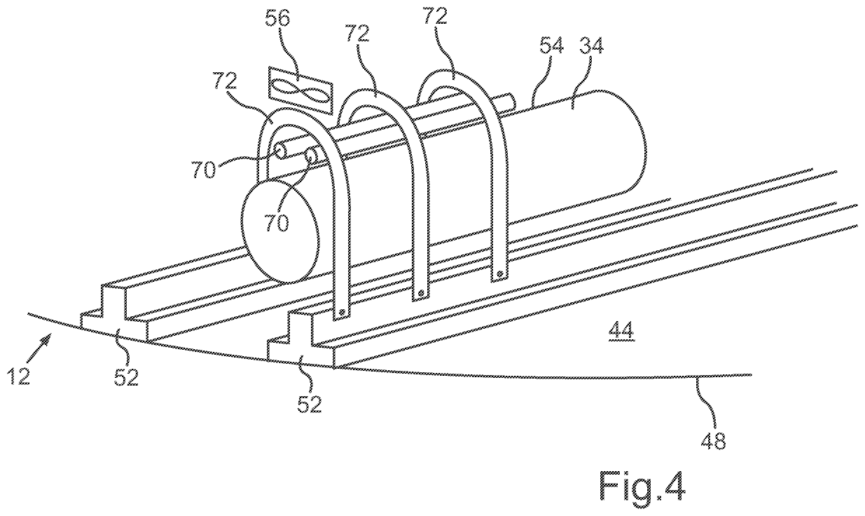

FIG. 4 shows, in schematic side view, a liquid coolant tank 34 of a cooling system 10 according to a further embodiment in interior space 44 of airplane wing 12. For purposes of mounting tank 34, mounting elements 72 are provided which, in the exemplary embodiment shown here, connect and secure tanks 34 to the lower stringers 52 of airplane wing 12. It can also be seen that a tank 34 may, for example, extend along the entire wing length or over a partial length of wing 12. A fan 56 is shown here above tank 34 to provide for air convection.

The exemplary embodiment includes two ground conduits 70 for connection of cooling units. Ground conduits 70 are mounted in interior space 44 of wing 12 in such a manner that they are in thermal interaction with tank 34 when the cooling units are connected.

### LIST OF REFERENCE NUMERALS

10 cooling system
11 cooling circuit
12 wing
14 fuselage
15 fuel tank
16 first heat exchanger
17 fuel feed line
18 fuel cell
19 propeller
20 coolant inlet
22 coolant outlet
24 electric propulsion system
25 conduit element
26 first pump
27 conduit element
28 second pump
29 conduit element
30 conduit element
32 tank system
34 tank
36 connecting element
38 inlet device
40 outlet device
42 second heat exchanger
44 interior space of the wing
46 upper shell
48 lower shell
50 spar
52 stringer
54 surface the tanks
56 fan
58 temperature sensor
60 temperature sensor
62 temperature sensor
64 feedback system
66 feedback system
68 feedback system
70 ground conduit for ground cooling
72 mounting element

What is claimed is:

1-15. (canceled)

16: A cooling system for cooling at least one element of an electric propulsion system of an aircraft, the cooling system being at least partially disposed within a wing of the aircraft and comprising:
a first and a second heat exchanger interconnected via at least one cooling circuit, the first heat exchanger being operatively connected to the at least one element to be cooled of the electric propulsion system, and the second heat exchanger being disposed within the wing and being operatively connected to an upper or lower wing shell of the wing.

17: The cooling system as recited in claim 16 further comprising at least one fan disposed within the wing.

18: The cooling system as recited in claim 16 wherein the cooling circuit includes a first conduit for supplying the liquid coolant to the first heat exchanger and a second conduit for conveying the liquid coolant away from the first heat exchanger.

19: The cooling system as recited in claim 16 further comprising a tank system having at least one tank for storing the liquid coolant, the tank system being disposed within the wing.

20: The cooling system as recited in claim 19 wherein the tank is configured to be useable as the second heat exchanger.

21: The cooling system as recited in claim 19 wherein a total weight of the tank system and the liquid coolant stored therein is determined as a function of a load and structural analysis of a weight ratio between a fuselage and the wings of the airplane.

22: The cooling system as recited in claim 19 wherein the tank system has a predetermined number of tanks and a predetermined distribution of the tanks balancing out a weight distribution in the wing of the aircraft.

23: The cooling system as recited in claim 19 wherein further comprising at least one fan disposed above or below each of the individual tanks of the tank system for convection of the air within the wing along the respective tank.

24: The cooling system as recited in claim 19 further comprising at least one sensor for sensing a temperature of the liquid coolant in the tank system or at least one sensor for sensing an air temperature within the wing or at least one sensor for sensing an outside temperature on the wing.

25: The cooling system as recited in claim 16 wherein the cooling system includes at least one ground conduit for ground cooling such that the ground conduit is in thermal interaction with a tank system disposed within the wing or with at least one heat exchanger, the heat exchanger being in thermal interaction with the tank system.

26: The cooling system as recited in claim 16 wherein the element to be cooled of the electric propulsion system is a fuel cell for powering the electric propulsion system or a fuel cell stack for powering the electric propulsion system or a battery for powering the electric propulsion system or an electric motor of the electric propulsion system or a housing of the electric propulsion system.

27: A wing for an aircraft, the wing comprising the cooling system as recited in claim 16.

28: An aircraft comprising the cooling system as recited in claim 16.

29: A method for cooling at least one element of an electric propulsion system of an aircraft, the method comprising at least the following steps:
a) providing the cooling system as recited in claim 16;
b) measuring a temperature in the region of the element to be cooled of the electric propulsion system; and
c) controlling the volume of flow or the velocity of flow of the liquid coolant in the cooling circuit according to a deviation of the temperature measured in step (b) from a predetermined desired temperature for the element to be cooled.

30: The method as recited in claim 29 further comprising the following steps:
d) measuring a temperature of the liquid coolant in the cooling circuit; and
e) controlling the volume of flow or the velocity of flow of the liquid coolant in the cooling circuit taking into account the temperature measured in step (d).
